(19) United States
(12) Patent Application Publication
(10) Pub. No.: US 2006/0037714 A1
(43) Pub. Date: Feb. 23, 2006

(54) Door cover

(76) Inventor: Richard J. Imbra, San Diego, CA (US)

Correspondence Address: Richard J. Imbra, 3312 Granada Ave., San Diego, CA, 92104, US

(21) Appl. No.: 10/921,437

(22) Filed: Aug. 19, 2004

(51) Int. Cl. E06B 3/32

(52) U.S. Cl. 160/90

(57) ABSTRACT

Door covers constructed of plastic sheeting and/or fabric are provided, such door covers being useful for protecting a door such as a security door or a screen door from weathering, and for protecting objects interior to the door. Also provided a window cover protectors, including plastic sheeting and/or fabric protectors that fit over and protect, for example, window screens and window bars.

### BACKGROUND OF THE INVENTION

1. Field of the Invention

The invention relates generally to articles useful for protecting an exterior door of a building and furnishings interior to the door, and more specifically to removable, flexible coverings that protect an exterior door such as a security door or a screen door from weathering, and that protect objects interior to the door from rain, snow, wind, and/or sun damage that can occur absent the door cover.

2. Background Information

Security doors are a common fixture on houses, out buildings, and commercial buildings. Security doors generally are constructed of varying grades of metal and, depending on the grade, can withstand varying battering forces. The doors generally are provided in a frame, and are installed utilizing large screws that can penetrate deep into a door jamb and are designed such that they cannot easily be removed, for example, by unscrewing. As such, they act to discourage forceful entry of an occupied or unoccupied building.

Security doors provide the advantage that an inner door to a house, for example, can be kept opened without concern that uninvited persons can enter into the house. Security doors also can be useful on buildings that are used seasonally, for example, summer cottages, acting, for example, as a deterrent to parties that may happen by the vacant building and otherwise consider forcing their way into the building to burglarize or vandalize it. Thus, security doors provide a line of defense against home invasion or other unwanted intrusions and, as such, are becoming increasingly common, in many areas supplanting screen doors and storm doors as the outside door of choice for a dwelling.

An advantage of security doors is that the design of the doors allows a person inside a house or other building to see and, if desired, converse with persons on the outside without the need to directly confront the visitor. Another advantage of security doors is that an internal door can be left open, thus allowing fresh air into a house without concern of an uninvited person entering the house. As a consequence, however, security doors provide little or no barrier to the weather, and readily allow the passage of rain, snow, and wind. As such, weathering of the door jamb, the inner door, and the space between the security door and inner door can occur. The potential for such weathering requires careful attention to assure that rotting of the wood door frame does not occur and that the area does not become suitable for mold growth or insect infestation. Further, since security doors are exposed to the weather, they are susceptible to rusting; rusted security doors are not an uncommon sight.

While security doors can be relatively inexpensive to buy and install, the manner in which the doors are bolted to house means that extensive labor often is involved in removing and/or replacing a security door. For example, removal of security door can require removing the head of the securing screws using a hacksaw, slipping the security door framing from the door jamb; then, depending on whether the door is to be removed or replaced, either removing the screw portion of the bolt by drilling and filling in the resultant hole, or simply covering the embedded screw portion with a putty or other material. As such, the cost for removing and/or replacing a security door can be several times greater than the initial cost of buying and installing the door. Unfortunately, except for vigilance and continued maintenance, convenient and cost effective ways for minimizing the weathering of security doors and of weather related damage to materials interior security doors have not yet been described. Thus, a need exists for articles that can act to protect security doors from weather related damage, and to further protect the jamb, inner door, and interior of a building having a security door.

### SUMMARY OF THE INVENTION

The present invention relates to articles of manufacture that can be used to cover a door, particularly the outside face of an exterior door of a building, thereby protecting the door from weather related damage. A further advantage of such articles, which are referred to herein as “door covers” or “door protectors”, is that, when used on a door such as a security door or a screen door, which can readily allow the passage of rain, snow, wind, and sunlight, the exterior door covers provide protection to materials and objects interior to the door, including, for example, the door jamb, an interior door, when present, and, when an interior door is absent or open, a room into which the exterior door (e.g., security door) opens. A door protector of the invention generally is designed to closely fit an exterior door such as a security door, thus protecting the door and objects interior to the door from weathering and weather related damage. An advantage of using a door cover of the invention to protect a security door, for example, is that a security door, which generally is provided as a unit with a frame, does not tightly fit the jamb (or frame), thus allowing the plastic or fabric material comprising the door cover to conveniently wrap around the door without affecting operation of the door.

A door cover of the invention need not necessarily be used only on an outside door of a building, but can be used on any door that one desires to protect, or in which it is desired to reduce or prevent an airborne material (e.g., water vapor) from passing through the door. Further, with simple modifications, a door protector of the invention can be used on a window covering such as bars or a grating that may be present on a window, thus providing protection of the window from weathering. Nevertheless, for convenience, reference is made herein with respect to a door, and particularly a security door such as the type having a metal grating, through which rain, snow, and the like can readily pass.

A door protector of the invention is referred to as having an inner surface (which is the side that is positioned against the exterior of a door to be protected), an outer surface (which is the side exposed to the elements), a top region (which extends toward, to, or over the top of a door), a bottom region (which extends toward, down to, or under the bottom of a door), a hinge side (which extends toward, to, or around the side of the door containing the hinges), and a lock side (which extends toward, to, or around the side of the door containing the lock and/or door knob). As such, the door cover, or a portion thereof, can, but need not, fit across the entire exterior side of the door, and can, but need not, further extend around one or more sides of the door to the interior side of the door.

Various designs are contemplated for a door cover of the invention, taking into account the requirement that the door cover not substantially impede working of the door hinges, the use of a door knob and/or key hole(s), a door lock cylinder, a dead bolt, or the like, and does not substantially impede opening or closing the door. As such, a door protector that completely covers the exterior side of a door and extends around the sides and to the interior side of the door can have, for example, cut out regions that prevent the door protector from impeding action of the hinges, or that allow a door lock cylinder to slide into and out of the door lock. The door protector also should allow ready access to keyholes and/or a door knob, preferably while maintaining protection of the door from the elements. For example, the door protector, at the position of a door knob, can contain a slit or cut, which can, but need not, be covered by a flap, thus allowing access to keyholes and/or a door knob without substantially reducing the protective quality of the door cover. Most doors generally are of a common size, usually about 72 to 96 inches in length and 30 to 36 inches in width (e.g., 30 inches by 72 inches; 30 inches by 80 inches; or 32 inches by 80 inches; or 36 inches by 80 inches), and have two or three hinges at regularly spaced intervals (e.g., for an 80 inch door, hinges can be at 4 to 8 inches, 38 to 42 inches, and 72 to 76 inches from top (or bottom) of the door. In addition, doors generally open from the right (i.e., hinges on the left) or from the left (hinges on the right), and have a door knob positioned between ⅓ and ⅔ of the way up from the bottom (e.g., about ½ way up; i.e., about 36 to 44 inches, e.g., 40 inches, from the top (or bottom) of an 80 inch door). As such, the door covers of the invention conveniently can be mass produced in only a few different sizes to fit most standard doors. In this respect, a door cover made to fit a first door that opens from the left and has a knob (and lock(s)) about ½ up the door, in one aspect, also can fit a second door that is substantially the same size as the first door, but opens from the right. Further, the door covers can be produced such that they allow sufficient leeway to accommodate moderate variations from standard door dimensions, or custom door covers can be prepared, for example, for more unique doors or having a desired feature such as a design or color of interest. An additional advantage of the door covers of the invention is that they can be placed on a door that is not attached to a building, for example, to protect the door from marring or damage during transport.

A door cover of the invention, which generally is about the size and shape of, or slightly larger than, a door on which it is to placed, can be attached to a door in any of numerous ways, provided that operation of the door is not substantially impeded. Preferably the door cover is attached by a means that allows one to quickly and conveniently place it onto or remove it from a door. As such, a door protector can have, for example, 1, 2, 3, or 4 corner pockets that can slip over corner(s) of the door, thereby holding the door protector on the door. A door cover also can contain an upper pocket and/or lower pocket that spans the top and/or bottom, respectively, of the door cover (and a door), thus allowing the door cover to be slipped over and/or under the door. A pocket of a door cover extends a distance along the interior of the door such that it does not substantially impede operation of the door hinges, which, for an 80 inch door, generally are about 3 to 4 inches from the top and bottom of the door. Thus, a pocket can be about 3 inches deep without concern that the door cover will bind a hinge or extend beyond the top of the door and impede closing of the door.

Corner pockets, particularly when present on more than one corner, or upper and/or lower pockets can further contain an elastic material that allows the door protector to be stretched over the door, thus providing a relatively tight fit of the cover on the door. Such an elastic material also can be positioned along one or both sides or can be positioned about the entire perimeter of the door cover (like a shower cap), thus allowing the door cover to be slipped over the door and provide a tight seal.

A door protector also can contain 1, 2, 3, or more vertical and/or horizontal straps that extend across the interior side of the door and can be used to hold and/or draw the door protector tightly against the exterior side of the door and hold the door protector in place. Such straps can be elastic or non-elastic straps that, in various aspects, extend, for example, from a top or bottom side of the door cover diagonally to a side, thus allowing the straps to be slipped over corners of a door; or vertically from the top to the bottom of the door protector, thus allowing the door cover to be slipped over the door from the lock side toward the hinge side; or can be a pair of straps, that extend toward each other from the top and bottom (or lock and hinge) sides and attach to each other on the interior side of the door; or can be a strap that extends from one side of the door cover (e.g., the top) and contains a fastener that attaches to a corresponding fastener (e.g., a hook and loop fastener) positioned on the opposite side (e.g., bottom) of the door cover.

A door cover also can be attached to a door by including on the door cover 1, 2, 3, 4, or more regions that contain a fastening material such as a hook and loop fastener (e.g., a Velcro™ fastener) or magnetic fastener (which can fasten the door cover to a door made of (or modified to contain) a ferromagnetic material such as steel or iron, or a paramagnetic material such as aluminum), or an adhesive material, particularly a relatively weak adhesive that has sufficient adhering strength such that it is maintained in position when exposed, for example, to typical wind conditions, but can be unstuck using moderate strength (e.g., an adhesive as contained on PostIt™ note paper). Combinations of attachment means also can be used to attach a door protector to a door. For example, the door protector can contain 1 or 2 corner pockets that can fit over the top (or bottom, or side) corners of a door, such pockets allowing for quick and convenient placement of the door cover onto the door, and can have fasteners (e.g., magnetic fasteners) along the bottom portion such that the door protector can be drawn up under (or over, or around the opposite side of) the door and fastened on the interior side of the door. It should be recognized that magnetic fasteners need not be constructed as part of a door cover, but can be provided separately (e.g., 1, 2, 3, 4, or more magnetic strips) and placed over the door cover, thus fastening the door cover to the door. A door protector also can have, for example, corner pockets that fit over the top corners of the door, and the door protector can be attached by drawing it under the bottom to the interior side of the door, where it can be attached using tape, which can be provided with the door protector or can be provided by the user (e.g., duct tape, or packaging tape).

A door cover of the invention can be constructed of any material suitable for the desired use, including, for example, plastic sheeting and/or a fabric. As disclosed herein, an exterior door cover not only can protect a door to which it is attached, but also can protect materials and furnishings interior to the door. As such, the door cover can be useful for protection against rain, snow, wind (as well as dust, allergens, etc., that can be carried by the wind), and sun light. Further, as a related advantage, a door cover of the invention can afford a degree of privacy (e.g., with respect to the inside of a dwelling) where, for example, the door cover comprises an opaque material.

A door protector can be composed of a plastic sheeting material, which can be clear, tinted, opaque, or colored, and can be of various thicknesses depending, for example, on the types of weather expected to be encountered, or on the length of time for which the door protector is to be used. Plastic door protectors provide the advantage that they can be manufactured relatively inexpensively and, therefore, can be sold at low cost and replaced as necessary, including relatively frequently (e.g., 2, 3, 4, or more times per year), without incurring a significant expense. They also can be included with a newly purchased door (e.g., a security door) and, as an incentive, can be included “free” with the purchase price of the door.

A door protector also can be composed of a fabric material that provides the requisite protection, for example, a breathable waterproof or water repellant material as used in the construction of awnings, tents, rain gear, knapsacks, and the like (e.g., GoreTex® fabric, a nylon fabric, or a cotton canvas fabric). A fabric door protector provides the advantages that it can be prepared in a desired color and/or having a desired design such that it complements a feature of a building on which it is to be used. Further, by constructing the door cover of a breathable material, it provides the additional advantage of allowing for humidity and/or odors in a room (e.g., a kitchen) to pass to the outside. A door cover also can be made of a combination of plastic and fabric materials, including, for example, a nylon material coated on one side with polyurethane, thus providing a water repellant door protector, or a cotton fabric having a laminated polyvinylchloride (PVC) backing, thus providing a water proof door protector.

The door covers of the invention are characterized, in general, in that they do not substantially impede normal operation of a door (e.g., opening and closing of the door). As further disclosed, however, the basic form of a door protector readily can be adapted for use on any object that is positioned over a fixed building opening and that readily allows the passage, for example, of rain, snow, or other airborne materials. Such fixed building opening covers are exemplified by window screens, including security screens, which are of a type and gauge of material that do not allow ready entry into the building; window bars; and the like. Accordingly, the present invention also provides window cover protectors, including, for example, window security screen protectors and window bar covers.

### BRIEF DESCRIPTION OF THE DRAWINGS

FIG. 1 provides an exterior view of a door cover 10 over a security door 20, which is in a door frame 30. A door lock cut-out 110, hinge cut-outs 120, and a door knob and dead bolt lock cut-out 130 are indicated. The door lock(s) cut-out 110 and/or door knob and dead bolt cut-out 130 can be effected, for example, by cutting off portions of the door cover such that hinge and lock operation is not impeded by the door cover; by “bunching” the door cover material at the hinge cut-outs 120 such that hinge operation is not impeded; and/or by fastening (e.g., using tape or a magnet) the door cover to the strike plate of the door at the position of the door lock(s) cut-out 110, such that closing and locking of the doors is not impeded. The door knob and dead bolt cut-out 130 can be effected, for example, by cutting out a portion of the door cover, or by placing a slit in the door cover such that the door knob and locks can be accessed. Optionally, the door cover can contain a flap that covers the door knob and dead bolt cut-out 130.

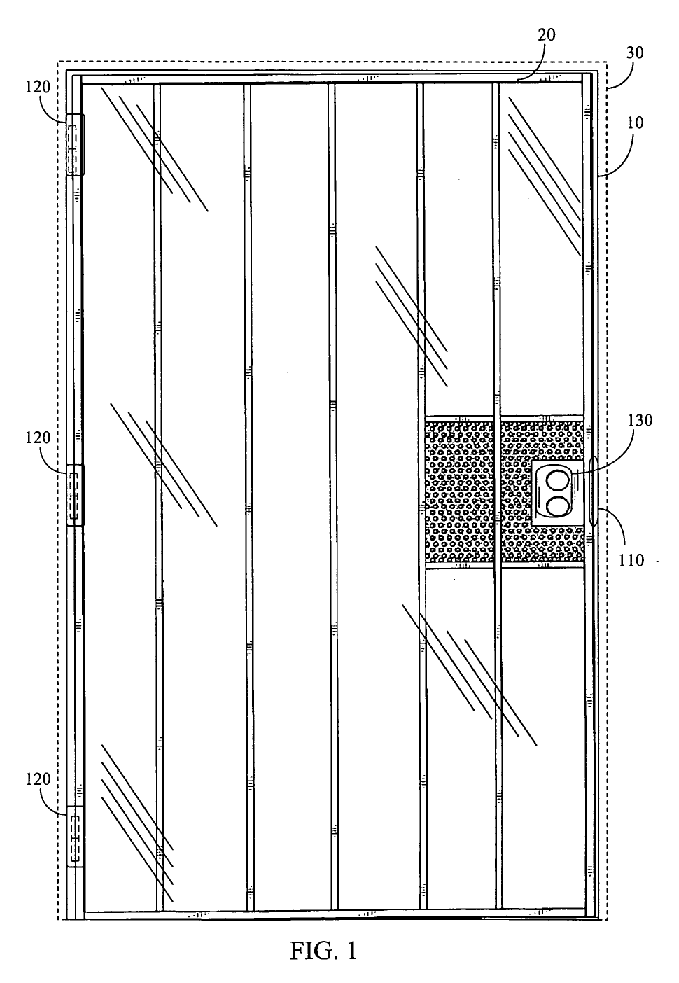

FIG. 2 provides an interior view of a door cover 10 on a security door 20. An upper pocket 140 and a lower pocket 145, which slip over the top and under the bottom, respectively, of the door are shown. Optionally, the door cover can be drawn to the interior of the door (e.g., at the positions of the arrows) and fastened (see, e.g., FIG. 3), such that the door cover fits tightly against the exterior door and flapping of the door cover due to wind or “ballooning” of the door cover due to opening and closing the door is minimized. Drawing of the door cover to the interior is limited, for example, by the hinges, which connect the security door 10 to a door frame (see, e.g., FIG. 1), and by the requirement that the door lock remain operational (see, e.g., FIG. 3). Fastening of the drawn portions of the door cover to the interior of the door can be effected using, for example, tape or magnetic strips, which can be provided with the door cover or can be provided by the user.

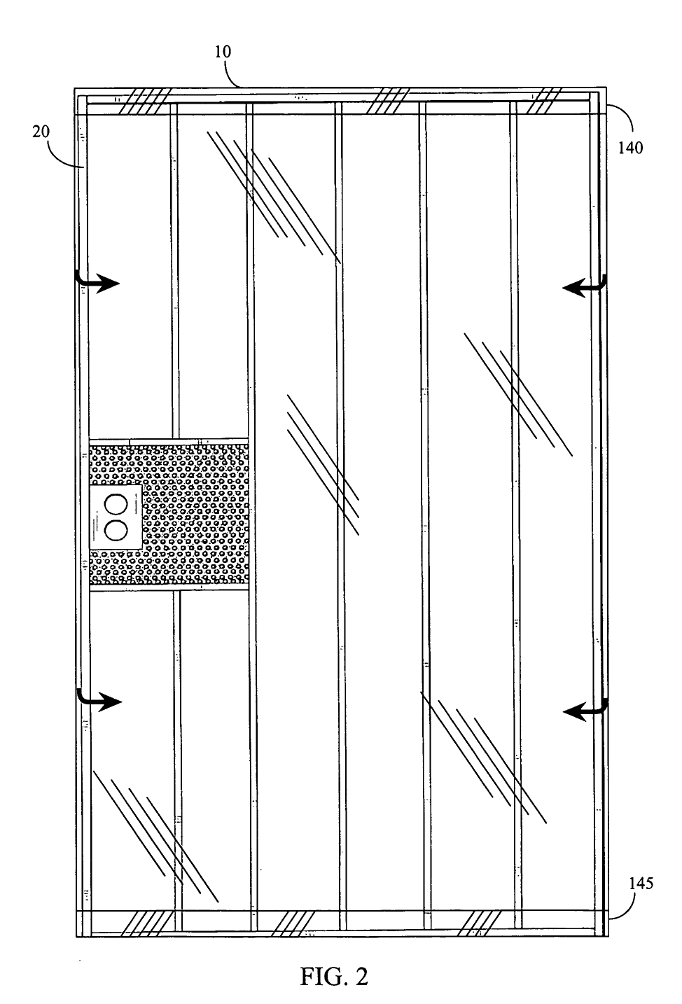

FIG. 3 provides another interior view of a door cover 10 on a security door 20, including an upper pocket 140 and a lower pocket 145, which slip over the top and under the bottom, respectively. Also shown are horizontal straps 150 and 151, positioned about ⅓ of the way from the top of the door cover. The door cover also can optionally include a fastener 155 (e.g., a hook and loop fastener), whereby, when the horizontal straps 150 and 151 are used to draw the door cover tightly across the exterior of the door, thereby pulling a portion of the door cover to the interior of the door, the fastener 155 can maintain the door cover taut. Pulling of the door cover to the interior is limited by the door hinges (not shown, but see, e.g., FIG. 1) and at the position of the door lock. The door cover can contain one or more additional horizontal straps and/or vertical straps, or can contain only one or more vertical straps.

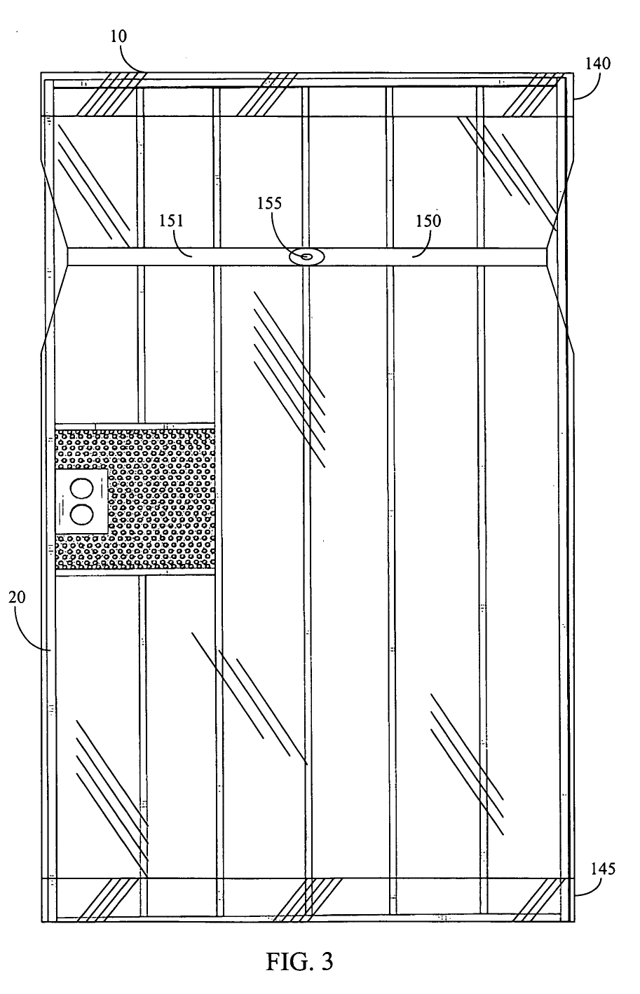

FIG. 4 provides an interior view of a door cover 10 on a security door 20, including an upper pocket 140, which slips over the top of the door, and a lower fold-over portion 160, which extends past the bottom of the door and can be drawn under the door (arrows). Also shown are fasteners 170, which provide a means to fasten the door cover to the interior portion of the door. The fasteners 170 can be, for example, magnetic fasteners (e.g., a magnetic strip), tape, or an adhesive material, which, optionally, can be provided with the door (either separately or as an integral component of the door cover), or can be provided by the user. Drawing of the lower fold-over portion 160 of the door cover allows the door cover to be fit tightly against the exterior of the door, whereby the fasteners 170 can fasten the taut door cover to the door.

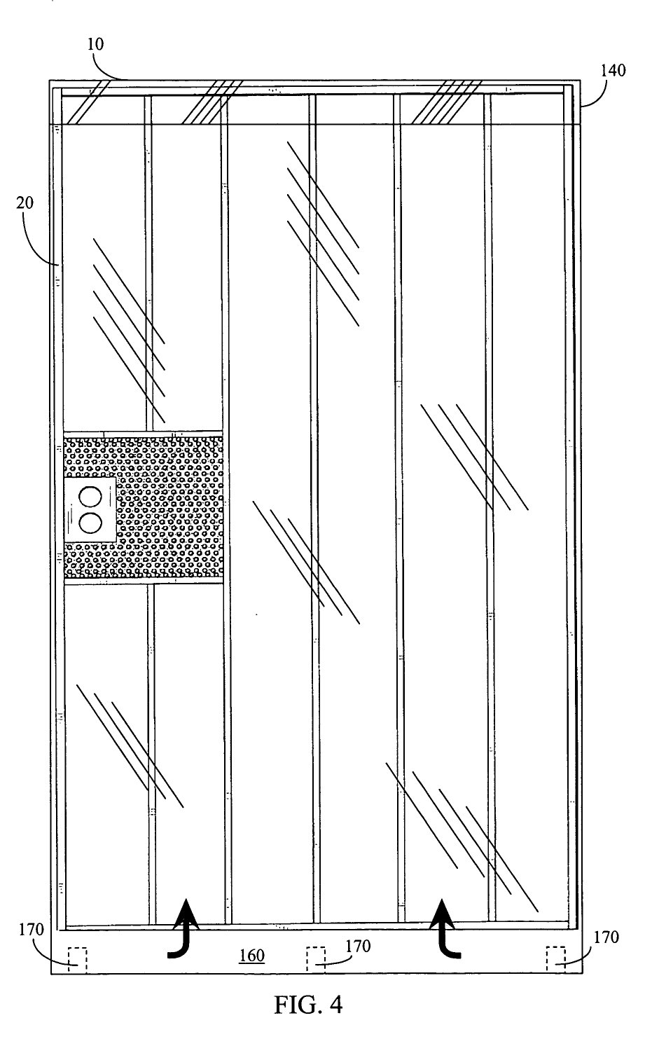

### DETAILED DESCRIPTION OF THE INVENTION

The present invention is based on the need to prevent weather related damage (e.g., rusting) of security doors, and of materials interior to such doors (e.g., rotting of door jambs or damage to a door or a floor interior to a security door), and the discovery that such weather related damage can be prevented using an exterior door cover that does not substantially impede operation and use of the door. Accordingly, the present invention provides exterior door covers, which fit onto and protect an exterior door as well as objects interior to the door, without substantially impeding use of the door (e.g., opening and closing, and locking and unlocking). The door covers can provide the additional advantage that, when constructed of an opaque material, they can provide privacy by preventing a person outside the door from looking into a building. A further advantage of the door covers of the invention is that they can be constructed of various materials, thus providing inexpensive door covers (e.g., door covers constructed of plastic sheeting), as well as door covers that complement an architectural feature of a building (e.g., door covers constructed of a fabric having a desired design such as an “arts and crafts” design, or a “modern” design; or that fit within the requirements of a Declaration of Covenant, Condition, and Restriction (“CCR”) by which a building is bound).

A door cover of the invention generally is a substantially flexible sheeting material or fabric that fits over an exterior side of a door, and protects the door and objects interior to the door from weathering without substantially impeding operation of the door. Optionally, the flexible sheeting material or fabric of a door cover allows the door cover to be repeatedly placed onto and removed from the door (i.e., placed onto and removed from the door two or more times). Alternatively, where a door cover may be needed frequently (e.g., during a rainy season), the door cover can be maintained on the door, but folded or rolled to the top (or bottom) when not needed. For example, a door cover containing a top pocket can be released from the door at the bottom, and rolled to the top (either manually or using a spring loaded mechanism (like a window shade), where it can be maintained until needed to fully cover the door. It should be noted that, while a door cover generally is placed on the exterior of a door, it also can be placed on the interior side of a door such as a security door, although such placement would not, for example, substantially protect the door from weathering.

As disclosed herein, a door cover of the invention generally is used on an exterior door of a building, particularly a security door or a screen door, but also can be used on any door in which it is desired to reduce or prevent transmission of an airborne material, wherein, without the door cover, the airborne material would readily pass from one room, through the door, into a second room. Further, while the door covers are described generally with respect to their ability to prevent entry of weather related elements such as rain into a building, the door cover also can be used to reduce or prevent transmission of an airborne material (e.g., dust) between rooms, or out of a room, through the door, into the environment, in which case it can be desirable to place the door protector on the side of the facing into the room containing the airborne material.

A door cover of the invention can be constructed of any of a wide variety of sheeting materials or fabrics, or can be constructed of combinations of sheeting materials, fabrics, and/or sheeting materials and fabrics (i.e., 1-ply, 2-ply, 3-ply, or more), which can be the same (e.g., to provide increased strength) or different (e.g., to provide different qualities). For example, a sheeting material useful for constructing a door cover can be plastic sheeting such as a type of plastic as used in drop cloths, shower curtains, and shower curtain liners (e.g., polyvinylchloride sheeting or polyethylene sheeting). As such, a door protector of the invention can be prepared using manufacturing methods typically used, for example, to produce shower curtains and shower curtain liners, with minimal re-tooling.

Generally, plastic sheeting useful for a door cover is of a sufficient grade and thickness such that it can provide the requisite protection (e.g., from rain, snow, wind, or sunlight damage), is sturdy enough to be removed and replaced a number of times, if desired, and is light and flexible enough to be easily handled and quickly and conveniently fit over and/or removed from a door, if desired. Plastic sheetings having a thickness in the range of about 0.5 mil to 8 mil provide an example of sheeting materials useful for constructing a door cover, as do materials such as 20 gauge to 40 gauge PVC vinyl sheeting. Plastic sheeting materials provide the advantage that they can be clear, thus allowing unhindered visibility through a door containing the door cover, or can be opaque, tinted, or colored, thus allowing for a degree of privacy, shading from sunlight, and the ability to obtain a door cover having a desired color. Plastic sheeting also can have an imprinted design.

Fabrics useful for constructing a door cover of the invention generally have a weight of about 20 to 1000 denier, and include, for example, cotton fabrics (e.g., canvas), nylon fabrics (e.g., DuPont™ Cordura Plus® nylon fabric, or DuPont™ Antron™ Cordura® nylon fabric), polyester or polypropylene fabrics, and fabrics constructed of a fluoropolymer such as polytetrafluroethylene (PFTE; e.g., DuPont™ Teflon® polymer fabric; and Gore-Tex® fabric). Fabrics provide the advantage that they are available in a nearly unlimited variety of colors and designs, thus allowing the construction of door covers that match or complement a color and/or architectural feature of a house, while providing the requisite protection. In addition, fabrics can be breathable (e.g., Gore-Tex® fabric), thus allowing, for example, humidity to escape from a room (e.g., a kitchen), through the door, to the outside, while, at the same time, preventing rain from coming into the room. Because some “fabrics” can be woven using a plastic material (e.g., polypropylene, which is a plastic, can be weaved into a fabric), it should be recognized that use herein of the term “fabric” can include fabrics made from or including a plastic type material.

Fabrics also can be conveniently treated to impart desirable qualities, including, for example, to make the fabric water resistant, water repellant, mildew resistant, ultraviolet light resistant, and/or flame retardant. For example, a nylon fabric (e.g., 400 denier nylon fabric) can be polyurethane coated to make it water repellant; or a nylon taffeta (e.g., 70 denier nylon taffeta) can be modified to contain a 3 mil PVC laminated backing to make it waterproof; or a polyester (e.g., 600 denier polyester) can be fused with a backing of 7 mil PVC to make it waterproof. These and other fabrics, plastic sheetings, and fabric/plastic sheeting combinations are well known and commercially available (e.g., from American Home and Habitat, Inc.; Squire Mo.; see, also, on the world wide web (“www”) at “ahh.biz”).

As such, a door cover of the invention can comprise two or more (e.g., 2, 3, 4, or more) sheeting materials and/or fabrics, including a first portion (i.e., a first sheeting material or fabric) and a second (or more) portion (i.e., a second (or more) sheeting material or fabric). Such first and second (or more) sheeting materials and/or fabrics can be the same (e.g., a two ply polyethylene sheeting material) or can be different from each other (e.g., an exterior Gore-Tex® fabric over a polyester wicking fabric), or can include two (or more) same sheeting materials and/or fabrics that are the same and at least one sheeting material or fabric that is different (e.g., cotton exterior and cotton interior layers with a PVC layer laminated between the cotton layers). Further, a door cover can include one (or more) portion of one type of sheeting material or fabric and a second (or more) portions of a different type of sheeting material or fabric (e.g., a primarily fabric door cover with a clear plastic sheeting portion at about eye level, thus allowing viewing through the door cover).

The present invention also provides a building opening cover protector, which is constructed of a flexible sheeting material and/or a fabric that fits over an exterior side of the dwelling opening cover, and protects the cover and objects interior to the cover from weathering without substantially impeding operation of the cover. The sheeting material or fabric can be any sheeting material fabric (or combination thereof) as exemplified herein or otherwise known in the art, and can have any of the features as disclosed herein or otherwise desired (e.g., a color or design to complement an architectural feature of the building). For example, the arts and crafts style is undergoing a revival and, therefore, a building opening cover protector (or door cover) of the invention can be constructed to have an art and crafts design (e.g., a design of Frank Lloyd Wright). Such arts and crafts (and other) designs are well known, and are amenable to application on mass produced articles such as the building opening cover protectors and door covers of the invention.

A building for which the use of a building opening cover protector of the invention can be advantageous can be any type of building having an opening (e.g., a dwelling) that has a cover, and the opening can be any type of opening, including, for example, a window or a vent (e.g., of a ventilation system), that has a cover. Although a building opening cover protector can be useful to protect any type of cover (or objects internal to the cover), the protector is particularly advantageous when used on a cover that opens (e.g., for cleaning) because the flexible nature of the sheeting material or fabric allows the cover to be conveniently and, if desired, repeatedly, fit over and removed from the cover, and because the protector, when fitted to the opening cover, does not impede operation of the cover. Examples of such building opening covers include window screens, which can be window security screens, and window bars, which, when on a dwelling, generally are required by building codes to be able to be opened from the inside; and vent covers, which prevent unauthorized entry into a building.

The present invention also provides methods of protecting a cover of a building opening, including, for example, an exterior door of a building, from weathering. Such methods are practiced by fitting a building opening cover protector over the cover. In one embodiment, the building opening cover is a door, wherein the method is practiced by placing a door cover of the invention over the door. In another embodiment, the method further protecting objects interior to the opening cover (e.g., door) from weathering.

Although the invention has been exemplified as described above, it will be understood that modifications and variations are encompassed within the spirit and scope of the invention. Accordingly, the invention is limited only by the following claims.

What is claimed is:

1. A door cover, comprising a flexible sheeting material or a fabric that fits over an exterior side of a door, and protects the door and objects interior to the door from weathering without substantially impeding operation of the door, wherein, optionally, the flexible sheeting material or fabric can be repeatedly fit over and removed from the door.

2. The door cover of claim 1, wherein the door is a security door or a screen door.

3. The door covering of claim 1, wherein the sheeting material or fabric is water resistant, water repellant, mildew resistant, ultraviolet light resistant, flame retardant, breathable, or a combination thereof.

4. The door cover of claim 1, wherein the sheeting material or fabric comprises a clear sheeting material.

5. The door cover of claim 1, wherein the sheeting material or fabric is opaque, tinted, or colored.

6. The door cover of claim 1, wherein the sheeting material or fabric comprises plastic sheeting.

7. The door cover of claim 6, wherein the plastic sheeting comprises polyvinylchloride sheeting or polyethylene sheeting.

8. The door cover of claim 1, wherein the sheeting material or fabric comprises cotton, nylon, polyester, polypropylene, or a fluoropolymer.

9. The door cover of claim 8, wherein the fluoropolymer comprises a polytetrafluroethylene polymer.

10. The door cover of claim 1, wherein the sheeting material or fabric comprises a first portion comprising a clear sheeting material, and a second portion comprising an opaque, tinted, or colored sheeting material or fabric.

11. The door cover of claim 1, wherein the sheeting material or fabric comprises a first portion comprising a first sheeting material or fabric, and a second portion comprising a second sheeting material or fabric.

12. The door cover of claim 11, wherein the first sheeting material or fabric is different from the second sheeting material or fabric.

13. The door cover of claim 12, wherein the first sheeting material or fabric comprises a first layer of the door cover and wherein the second sheeting material or fabric comprises a second layer of the door cover.

14. The door cover of claim 13, which comprises a nylon fabric coated with polyurethane.

15. The door cover of claim 13, wherein the first sheeting material or fabric is laminated to the second sheeting material or fabric.

16. The door cover of claim 15, which comprises a PVC sheeting material laminated to a nylon fabric.

17. A dwelling opening cover protector, comprising a flexible sheeting material or a fabric that fits over an exterior side of the dwelling opening cover, and protects the cover and objects interior to the cover from weathering without substantially impeding operation of the cover, wherein, optionally, the flexible sheeting material or fabric can be repeatedly fit over and removed from the cover.

18. The dwelling opening cover protector of claim 17, wherein the dwelling opening comprises a window.

19. The dwelling opening cover protector of claim 18, wherein the cover comprises a screen or bars.

20. The dwelling opening cover protector of claim 19, wherein the screen comprises a security screen.

21. A method of protecting an exterior door of a building from weathering, comprising fitting a door cover of claim 1 over the door.

22. The method of claim 21, further comprising protecting objects interior to the door from weathering.
